(19) United States
(12) Patent Application Publication
(10) Pub. No.: US 2008/0237909 A1
(43) Pub. Date: Oct. 2, 2008

(54) Mould for Preparing Large Structures, Methods of Preparing Mould and Use of Mould

(76) Inventor: Anton Bech, Ringkobing (DK)

Correspondence Address: STITES & HARBISON PLLC, 1199 NORTH FAIRFAX STREET, SUITE 900, ALEXANDRIA, VA, 22314, US

(21) Appl. No.: 10/599,152

(22) PCT Filed: Mar. 22, 2004
(86) PCT No.: PCT/IB04/50308

§ 371 Date: Sep. 21, 2006

(51) Int. Cl. B29C 70/02

(52) U.S. Cl. 264/101; 425/405.2; 264/219

(57) ABSTRACT

A mould (2) for preparing of large structures, such as wind turbine blades, is provided. Furthermore, methods of manufacturing and use of such a mould (2) are provided. The mould (2) comprises a support structure (4), an air-drainage structure (6) and an air-permeable surface member (8). Ile mould is particularly suitable for preparing of moulded items with an in-mould coating.

### TECHNICAL FIELD OF THE INVENTION

The present invention relates to a mould for preparing large structures, such as wind turbine blades. Particularly, the present invention relates to a mould comprising an air-permeable surface member and an air-drainage structure, a method of preparing such an air-permeable surface and a method of use of such a mould. Such a mould is particularly suitable for the manufacturing of a wind turbine blade with an in-mould coat.

### BACKGROUND OF THE INVENTION

Many composite items are prepared with a coating. Traditionally, the item has been painted after moulding. Today, it is known to process the item with an in-mould coating, such as a thermoplastic film, to form a surface film. During processing, the film has be to held to the surface of the mould either by sucking the film onto the tool surface by vacuum or by pressing the film down onto the tool surface by air or mechanical pressure. Pressing the film down is not suitable for large size mouldings, such as a wind turbine blade or shell, as the matching mould and press would have to be very large and therefore expensive and difficult to handle. In-mould coating of large structures, therefore, has in practice to rely on vacuum technique.

Unfortunately, air tends to become trapped between the film and the mould during evacuation resulting in undesired shape of the moulded item. Various attempts to prevent such trapping of air by modifying of the mould surface texture has been performed, including placing a textile cloth on the mould surface, having a coarse sanded mould surface and having a number of larger vent holes in the mould surface. However, for hot cure none of these alternatives are acceptable as the film will soften during the cure cycle of the moulded item and therefore an imprint of the texture of the mould surface will be produced in the film, resulting in an unacceptable surface finish of the coating on the moulded item.

Large moulds, such as moulds for wind turbine blades or shells, are typically made in composite materials or welded metal sheets. Despite measures to ensure an airtight mould, such moulds will often have some porosity or micro cracks leading to air leaking through the mould wall. An air leak under the film will in most cases make a drop in vacuum under the film resulting in the risk that the film does not stay firmly attached to the mould during processing of the item to be moulded. Furthermore, air leaks will result in sink marks on the moulded item.

In Japanese patent application 07047595 (Pubn.) a vacuum or compressed air moulding tool is used for shaping of a synthetic resin board. A number of small air-permeable members are dispersed to form a limited part of the surface of the mould body. The air-permeable members are prepared by sintered metal powder or foamed heat-resistant plastic. It is emphasised that the main part of the mould is not air-permeable, amongst others due to durability considerations. Such a mould is rather complicated to produce and is not suitable for moulding of large items. Japanese patent application 07047595 (Pubn.) is completely silent with regard to applications for in-mould coating and suitability for moulding of other items than synthetic resin boards.

### OBJECTS OF THE INVENTION

In one aspect of the invention, it is the object to provide an improved mould for large structures.

In another aspect of the invention, it is the object to provide a method of manufacturing such a mould.

In a further aspect of the invention, it is the object to provide a method of use of such a mould.

### DISCLOSURE OF THE INVENTION

The above and other objects of the invention are realised with the mould according to claim 1 for preparing a wind turbine blade, a shell for wind turbine blade or a part of a wind turbine blade. This mould comprises a support structure, an air-drainage system, an active mould surface and an air-permeable surface member. Air may be transported between the active mould surface and the air-drainage system through the air-permeable surface member. For this mould, the air-permeable surface member forms substantially the entire active mould surface.

The term wind turbine blade herein means a complete wind turbine blade, a shell for a wind turbine blade or a large member intended to form part of a wind turbine blade, the structure optionally having incorporated reinforcing elements, unless one or more of these are recognised by the skilled person to be inappropriate for a specific embodiment or where this is indicated. Relevant large members are e.g. a base part or a tip part of a blade, a major part of a front or back shell and a reinforcing member, such as a spar, etc.

The mould according to the invention is advantageous over prior art moulds in that it provides the ability to manufacture very large moulded items, such as a wind turbine blade, and one or more of: more robust air-removal from the mould via the air-permeable surface member and the air-drainage system; increased tolerance to air leakage through the support structure; reduced number and size of sink marks in the moulded item; ability to provide in-mould coating; and improved surface finish of the moulded item.

The aspect of a manufacturing of the mould is realised by a method according to claim 34, wherein the air-drainage system optionally is manufactured by the method according to claim 32 and the air-permeable surface member optionally is manufactured by the method according to claim 33.

The aspect of utilising of the mould is realised by a method of use according to claim 36 or 37.

These and further aspects within the inventive concept are discussed further in the following and exemplified in a number of non-limiting preferred embodiments with reference to the figures.

### BRIEF DESCRIPTION OF THE DRAWINGS

The invention will be explained more fully below with reference to particularly preferred embodiments as well as the drawings, in which

FIG. 1 shows a cross sectional view of a mould according to the invention,

FIG. 2 shows preferred embodiments of the network for transport of air comprising channels,

FIG. 3 shows preferred embodiments of the network for transport of air comprising islands of solid material,

FIG. 4 shows preferred embodiments of the network for transport of air comprising islands of solid material which are connected by connections,

FIG. 5 shows embodiments of the air-drainage system, which is integrated with the support structure and/or the air-permeable surface member,

FIG. 6 shows embodiments of the air-permeable surface member having different passage structures, and

FIG. 7 shows further embodiments of the air-permeable surface member having different passage structures.

All the figures are highly schematic and not necessarily to scale, and they show only parts which are necessary in order to elucidate the invention, other parts being omitted or merely suggested.

### DETAILED DESCRIPTION

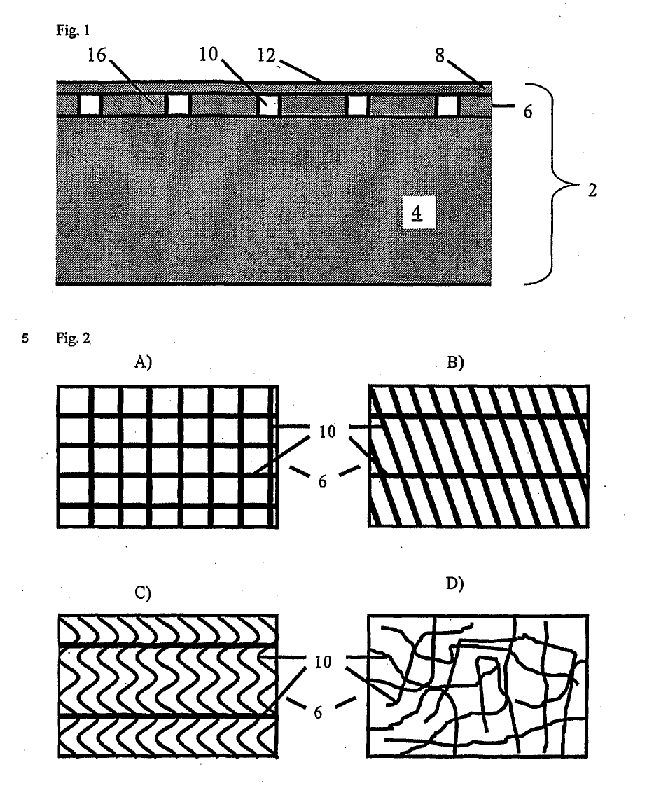

The mould according to the invention is typically rather large, such as in the order of 10 to 70 meters and to be able to identify smaller features, only limited sections are shown in the figures. This is also the case in FIG. 1 where a cross section of a mould 2 is shown.

The mould in FIG. 1 has a support structure 4 to which an air-drainage system 6 is connected. Finally, an air-permeable surface member 8 is positioned on the air-drainage system 6 to form the active mould surface 12.

### Support Structure

The support structure 4 typically provides a major part of the load-bearing ability of the mould even though in some embodiments the air-permeable surface member and/or the air-drainage system may account for a significant part of the load bearing. Furthermore, the support structure usually provides the rough shape of the active mould surface even though the air-permeable surface member and/or the air-drainage system may provide smaller adjustments in the shape.

The support structure 4 may be manufactured dedicated to a mould according to the present invention or the support structure may itself be or comprise a mould, which e.g. may have been used for another purpose. In this case, the manufacturing of the mould according to the invention may be considered as a renovation or reconstruction of the old mould.

The support structure may provide the support for the air-drainage system and the air-permeable surface member in various ways. For example the support structure may comprise or even just consist of ribs, which ribs may optionally be interconnected, or the support structure may form a partial or an entire surface substantially parallel to the intended active mould surface. In a preferred embodiment, the support structure forms an entire surface, which is substantially airtight. &p In a preferred embodiment, the support structure comprises metal sheets or composite material such as fibre-reinforced plastic, as this provides a support structure with suitable and reproducible properties.

### Connection of Components

The support structure 4, the air-drainage system 6 and the air-permeable surface member 8 may be secured in the described order simultaneously, e.g. by a fastener, such as needles, screws or equivalent, or by an adhesive, securing the air-permeable surface member 8 to the support structure 4 via the air-drainage system 6. Alternatively, the structure may be prepared by separately affixing, e.g. by a fastener or adhesive, the air-drainage system 6 to the support structure 4 and the air-permeable surface member 6 to the air-drainage system 6. Yet another way to arrive at the mould according to the invention concerns the situation, where at least one of the components comprises a curable resin or a partially cured resin. In this case, the securing may take place as an integrated part of the curing of such components, e.g. by chemical or mechanical bonding of the curing resin to adjacent components. It is preferred that the securing is achieved by adhesive, as this method may provide stable securing, which is easy to scale up.

### Air-drainage System

The air-drainage system comprises a means for transportation of air out of the mould, and, optionally, in cases such as when a moulded item is to be released from the mould, air into the mould. The air-drainage system may comprise a number of independent air-drainage structures, such as channels or grooves. However, it is highly preferred that the air-drainage system 8 comprises a network for transportation of air, I.e. cross-linked air-drainage structures, as this provides an air-drainage system, which is much more robust in case of air leakage through the support structure or blocking of the air-drainage structures.

In the Japanese patent application 07047595 (Pubn.), air is removed from the air-permeable members through channels, which are drilled substantially orthogonal to the active mould surface, to an open space covering the complete back of the mould from where air apparently may be evacuated. This design of the channels renders the mould very vulnerable-to failure of air-removal if a channel is accidentally plugged by moulding material contrary to the present invention where accidental plugging is compensated for by neighbouring channels.

It is highly advantageous when the air-drainage system 6 according to the present invention is a network, as this provides for a more robust design in relation to accidental blocking of a part of the air-drainage system 6, since numerous drainage routes exists for all areas in such an air-drainage system 6. Furthermore, a network will provide an air-drainage system 6, which is less sensitive to air leaking into the mould, such as via micro cracks or porosity in the support, as the numerous ramifications provide for a reduction of the local pressure drop and lead to a reduction of the number and extent of sink marks in the moulding.

In FIG. 2 a number of embodiments of the network of the air-drainage system 6 is shown. The network may be regular, e.g. as indicated in FIG. 2A, random, e.g. as indicated in FIG. 2D, a partially systematic system, e.g. as indicated in FIG. 2B and C, or any combination of these. The pattern most advantageous for a particular application may depend on a number of conditions, such as size and material of the mould, number of moulds to be produced, material to be processed in the mould, etc. As the air-drainage system 6 is used to transport air from the air-permeable surface member 8, it is preferred that the air-drainage system 6 substantially follows the active mould surface 12. This is also true if variation in the overall thickness occurs for the air-drainage system 6 or the component with the air-drainage system 6 if the air-drainage system 6 be integrated into another component, such as the support structure 4 or the air-permeable surface member 8.

In a preferred embodiment according to the invention, the air-permeable surface member 8 and/or the air-drainage system 6 is secured in a way that is releasable to the air-drainage system 6 and the support structure 4, respectively. This provides for an easy access to the network of the air-drainage system 6, e.g. for cleaning or removal of undesirable blocking.

In one embodiment of the invention, the air-drainage system 6 comprises channels 10 for transport of air, Such channels may be straight or curved and the size, i.e. the cross sectional area, should be sufficient to allow for removal of the necessary amount of air. Experimental results have shown that this may be achieved if the cross section of most of the channels 10 for transport of air is greater than 1 mm². However, for very large moulds the cross section may need to be greater to reduce the pressure drop and cross sections greater than 4 mm² or even greater than 9 mm² may be more advantageous. The channels should be sufficiently small to ensure that the air-drainage system 6 provides sufficient structural strength to support the air-permeable surface member 8. The cross section of the channels 10 may e.g. be about 1 to 2 mm deep and about 1 to 2 mm wide. This should typically be sufficient to prevent blocking during preparation of the mould, e.g. by adhesive, and prevent too high stress on the air-permeable surface layer 8 covering the channels.

The distance between neighbouring channels 10 running substantially in the same direction, such as parallel channels, may vary considerably, but in a preferred embodiment, this distance is between 0.4 cm to 20 cm for some or all of the channels. Experimental results have shown that distances between 0.5 cm to 5 cm, such as about 1 to 2 cm, are suitable for moulds for manufacturing of wind turbine blades.

To form a network, the channels must cross. The distance between crossings should be limited as the crossings reduce the influence of local blockage or leakage through the support structure 4. In a preferred embodiment, the distance between the crossings of channels 10 for transport of air is 0.5 cm to 20 cm for at least some of the crossings. Experimental results have shown that distances between 0.7 cm to 5 cm, such as about 1 to 2 cm, are suitable for moulds for manufacturing of wind turbine blades.

In another embodiment of the present invention, the air-drainage system 6 comprises islands 16 of solid material and the space between these islands 16 forms a part of the network for transport of air. For example, the space between the islands 16 may be supplemented with channels 10 as described above. In this case, the channels 10 may e.g. provide for transportation of air over longer distances, whereas the space between the islands 16 could account for the transportation of air on a local scale. In another embodiment, the space between the islands 16 forms the two-dimensional network for transport of air and hence provides for air transportation on both local and longer scale. A mould having an air-drainage system 6 comprising the above described islands 16 is advantageous in having a high degree of flexibility with regard to cross section and shape of the individual spaces between the islands compared to just having crossing channels.

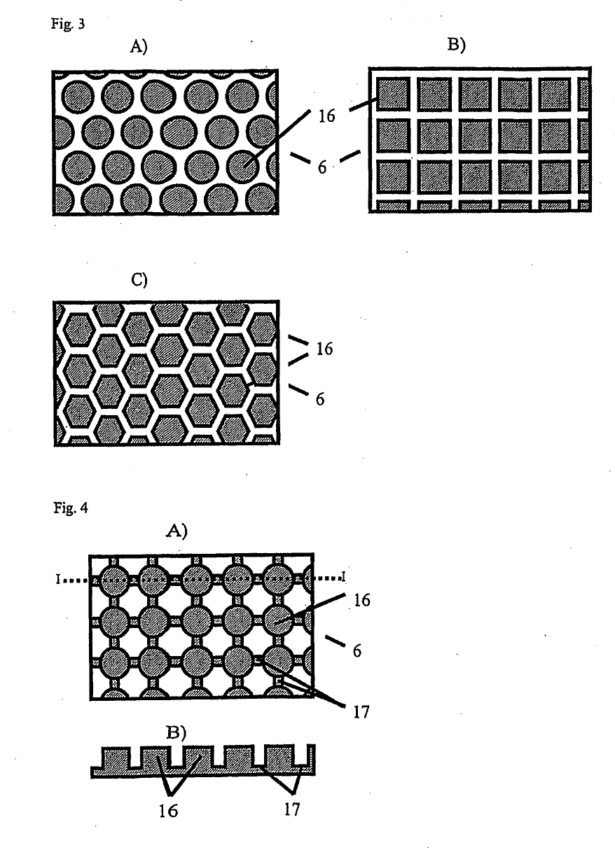

In FIG. 3, examples of networks for transportation of air in an air-drainage system 6 with islands 16 are shown. In FIG. 3 relatively small islands 16 are utilised. This is particularly feasible if the air-permeable surface member 8 to be positioned on the islands 16 is highly rigid and itself provides for a substantial structural strength. The network is very open and therefore provides for a very low-pressure drop and a very low effect of local blockage or leak through the support structure 4. In FIG. 3B and C, larger islands 16 are utilised. This provides for a better support for the air-permeable surface member B.

In FIG. 3 only a limited number of island shapes has been shown, however, from this the person skilled in the art would be able to deduce a wide range of other suitable island shapes including circles, triangles, quadrangles and other polygons. Dependent on the actual application some of, most of or substantially all of the islands have one of these shapes. Furthermore, different types of island shapes and sizes may advantageously be mixed. This may e.g. provide a mould, which has the most suitable compromise between the openness of the network and the ability to support the air-permeable surface member 8 on a local scale and hence account for different requirement in different areas of the mould.

An air-drainage system 6 comprising islands 16 of solid material may advantageously be prepared directly on the support structure 4 by casting a curable tooling paste over a mesh resembling the desired network for air transportation, curing the tooling paste and removing the mesh. Alternatively, individual islands may be prepared separated from the support structure 4 and later adhered or in another way fastened to the support structure 4. This alternative method is particularly relevant when a mould with a limited number of islands are prepared.

In FIG. 4 an example of islands connected by connectors are shown. To ensure a good control of the relative positioning of islands, particularly during manufacturing of the mould, but also to avoid having to secure each individual island, two or more of the islands 16 are in a preferred embodiment connected by a connector 17. In FIG. 4A, the islands and connectors are seen from above and in. To ensure that the network for air transport is kept open, the height of such a connector is smaller than the height of the islands 16. An example of relative heights of the islands and the connectors is shown in FIG. 4B, which corresponds to a cross section of the network shown in FIG. 4A along the line I-I. The connectors 17 are preferably made from the same material as the islands, however, in some cases another material may be used for the connectors. An example of this is when the connector comprises reinforcement fibres, such as glass fibres or carbon fibres and the island is made from a curable resin, however, such a resin may comprise fibres with another length.

An air-drainage system 6 having islands and connectors may advantageously be prepared in plastic or fibre-reinforced plastic in a separate mould and after partial or complete curing transferred to the mould to a support structure.

In a particularly preferred embodiment of the invention, the network comprises channels with different cross sections. The fine channels provide for air transport on a local scale and the coarser channels provide for air transport on a larger scale, such as the width or length of the mould. As the fine channels may be positioned relatively close without significantly reducing the structural strength of the air-drainage system 6, such a network allows for very efficient air transport both on a local and on a larger scale with a reasonable pressure drop.

The air-drainage system 6 is intended to be airtight in the mould except towards the air-permeable surface member 8 and one or more openings to a pressure control system, such as a vacuum system or a pump capable of providing pressurised air and/or vacuum. By intending to be airtight, it is considered that the invention amongst other aspects is intended to reduce the influence of accidental air leaks into the mould 2 and/or the air-drainage system, e.g. through the support structure 4. It is hence acknowledged that a mould is prepared with the intention that it should be airtight, but in reality this is not always possible to realise. It is in other words not a goal to have air leakage, but this is often the result when manufacturing, using or re-using large moulds.

For large moulds it may be advantageous to use more than one pressure control system, such as 2, 3, 4, 5 or even more, which are connected in separate openings or the same opening. Particularly when the pressure control systems and respective openings to the air-drainage system 6 are distributed along the length of the mould, this reduces the distance that air has to be transported within the air-drainage system 6. In one embodiment of the invention, the air-drainage system 6 is separated into two or more independent air-drainage systems 6, i.e. systems without air transport between them. This allows for different pressure in the individual systems and even the option of forming the mould of smaller independent-segments and hence increases the handleability of the mould.

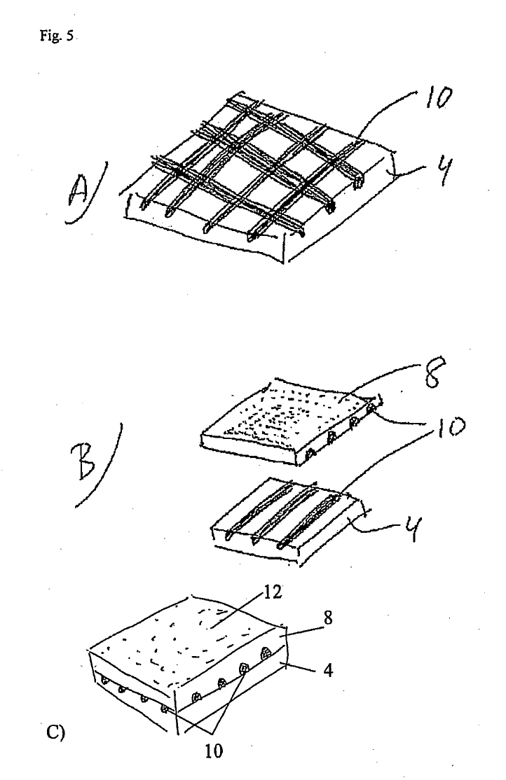

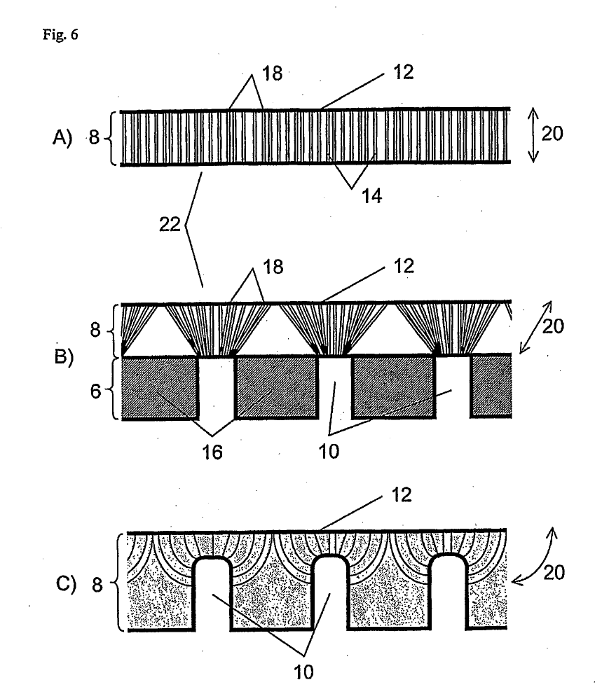

The air-drainage system 6 may be formed by being positioned between the support structure 4 and the air-permeable surface member 8 for example formed as one independent member (as shown in FIG. 5A), or as a number of connected or unconnected islands 16 (as shown in FIG. 1, FIG. 3 and FIG. 4). As shown in FIG. 56 and FIG. 6C, the air-drainage system 6 may be integrated into the support structure 4 and/or the air-permeable surface member 8.

The air-drainage system 6 In FIG. 5A having the air-drainage system 6 in an independent component is e.g. advantageous when the support structure 4 does not form an entire surface parallel to the intended active mould surface and the air-drainage system 6 therefore has to provide for the mould being airtight towards the support structure 4.

The air-drainage system 6 may also be fully integrated with the air-permeable surface member 8 shown in FIG. 6C. The channels 10 are connected by other crossing channels (not shown) in other planes of the air-permeable surface member B. The combined air-permeable surface member 8 and air-drainage system 6 may e.g. be prepared during moulding or by introduction of grooves or other recesses, e.g. by grinding, milling or cutting. The air-drainage system 6 may similarly be integrated with the support structure 4 (not shown).

The air-drainage system 6 may also be partially Integrated with the support structure 4 and the air-permeable surface member 8 for example as shown in FIG. 5B. Here, the support structure 4 has channels 10 incorporated for air transport in one direction and the air-permeable surface member 8 has incorporated channels 10 for air transport in another direction. Hence, the network for transport of air is formed when the air-permeable surface member 8 and the support structure 4 are connected as shown in FIG. 5C. In another embodiment, fine channels are present in one component, e.g. the air-permeable surface layer, and larger channels in another component, e.g. the support structure. In a further embodiment, a dedicated component with channels in one direction may be provided between the support structure and the air-permeable surface layer and the network for air transportation formed by the combination with channels in the support structure or the air-permeable surface layer, wherein these channels are oriented in another direction. Other similar ways to realise the air-drainage system 6 by partial integration with the support structure 4 and/or the air-permeable surface member 8 will based on these embodiments be apparent to the person skilled in the art.

### Air-permeable Surface Member

As shown in FIG. 1, the air-permeable surface member 8 forms part of the active mould surface 12 on the first side and connected to the air-drainage system 6 on the second side. The air-permeable surface member may provide for, or assist in a number of the possible advantages of the mould according to the present invention, including the improved surface finish of the moulded item, the reduced number of and size of sink marks in the moulded item and the ability to provide in-mould coating.

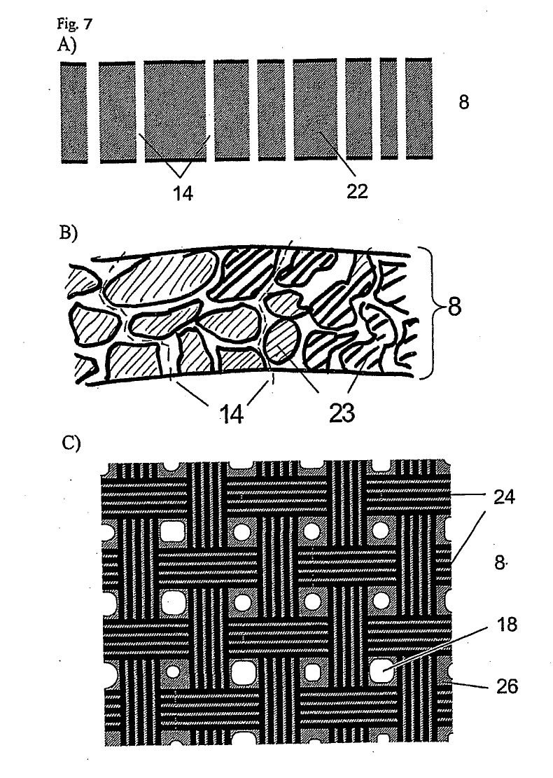

In FIG. 7, examples of close-up cross sections of air-permeable surface members 8 are shown. The air-permeable surface member possesses the ability to transport air through the air-permeable surface member 8 via passage structures 14, e.g. between the active mould surface 12 and the air-drainage system 6. To ensure a good surface finish of the moulded item, the openings 18 of the passage structures 14 towards the active mould surface 12 should be relatively small. In a preferred embodiment, most of these openings 18, such as about 90%, 95%, 98% or more on a number basis, of the openings 18 cover an area of the active mould surface 12 corresponding to a circle with a diameter of less than 0.5 mm. During use, thermoplastic material will penetrate into the openings and surface tension considerations hence suggest that smaller openings are more desirable. In a more preferred embodiment, the corresponding diameters of the openings are therefore between about 10 μm to 250 μm or even between 250 μm to 150 μm, such as between 50 μm to 125 μm. In general, the smaller the diameters of the opening, the less material will penetrate into the openings and hence more perfect the moulded surface. Furthermore, the probability for thermoplastic material to get stuck in an opening or a passage structure decreases when the diameter of the opening is reduced and the depth of penetration into the openings is reduced correspondingly. The thermoplastic material also influences the depth of penetration into the openings. It was e.g. found that for a particular mould having openings of about 250 μm, the penetration was about 20-30 μm for an acrylic in-mould coating, whereas under the same processing parameters the penetration was only about 4 μm for a nylon in-mould coating.

To ensure a very even removal of air from the active mould surface 12, a high number of openings in the active mould surface 12 is used. The number of openings 18 should be one or more pr cm² but on the other hand typically smaller than 1000 pr cm². Typically, 2 to 200 openings pr cm² is suitable for normal uses and about 5 to 100 openings pr. cm² has been found to be very advantageous. The optimum density depends on parameters such as the air-transportation distance, the opening size, the passage structure cross-section size and the type of passage structure.

In FIG. 6A a sheet of dense material 22, such as plastic or metal, has been perforated e.g. by drilling or electron beam perforation and a number of straight passage structures 14 are present. The passage structures are oriented substantially orthogonal to the active mould surface 12. For this air-permeable surface member 8 a number of passage structures will be blocked when connected to the air-drainage system. The air therefore has to travel along the active mould surface before arriving at an effective passage structure. However, the size of the individual areas of the active mould surface, which have blocked transportation passages, will be limited and in the order of the distance between the channels of the air-drainage system. Larger amounts of air can hence not be caught at the active mould surface.

In FIG. 6B, this has been done by orienting the straight passage structures towards the channels 10 of the air-drainage system 6. In other words, the number of passage structures leading from the active mould surface 12 to an island 16 of the air-drainage system 6 has been limited. The air-transportation distance indicated by the length of the arrow 20 is increased.

In FIG. 6C, the situation for a porous air-permeable surface member 8, such as a powder metal or a fibre-reinforced plastic, which is deficient in resin, is indicated. Here, the passage structures are typically not straight, but a combination of more or less randomly distributed pores and holes. Thus, air may also be transported parallel to the active mould surface and all openings may, potentially, be connected to the channels 10 of the air-drainage system, which in FIG. 6C is integrated in the air-permeable surface member 8, but also could be a separate component or integrated in the support structure. The air-transportation distance 20, however, is increased considerably.

In a preferred embodiment of the invention, the openings are distributed substantially evenly over the side of the active mould surface formed by the air-permeable surface member, however, if e.g. the opening size or the air-transportation distance varies, an uneven density of passage structure openings may be advantageous in some cases.

The structure of the passage structures depends on the material and manufacturing method of the air-permeable surface member. The air-permeable surface member of the mould according to the present invention may advantageously be prepared by one of the following methods or a combination of two or more of these methods:
Sintering a powder under conditions, which provides a non-dense sintered materials. The powder may e.g. be a metal powder. The sintering may involve chemical reaction and/or a redistribution of material to form a coherent member;
   a) Curing or partially curing a thermosetting resin with fibres under conditions where an inferior volume of thermosetting resin relative to fibres is used. A non-dense member will therefore be formed. The fibres are preferably glass fibres and/or carbon fibres, but other types of fibres may also be used.
   b) Curing or otherwise solidifying a foamed material. The foamed material is preferably a thermoplastic resin or a metal. The foamed material may optionally be treated to increase the permeability of the component.
   c) The combination of the following steps:
Providing a dense or nearly dense, solid material, such as a sheet of metal or thermosetting plastic, optionally reinforced by fibres, such as carbon fibres and/or glass fibres, and
Perforating the material by drilling or by electron beam perforation. The drilling may e.g. be carried out as mechanical-drilling, water drilling, laser drilling. These types of perforating lead to formation of substantially straight and equally sized passage structures for air transportation. The pressure drop and air transportation may therefore relatively easily be modelled for optimisation of the design.

The perforation methods described in c) above may also be used to increase the number of passage structures in air-permeable surface member prepared by method a) and b) above.

In a preferred embodiment, the air-permeable surface member comprises a metal with low reactivity towards the typical materials to be used for the mouldings and particularly thermoplastics used for the in-mould coating. Examples of such metals are steel, aluminium and alloys comprising one or more of these.

In a preferred embodiment, the air-permeable surface member comprises plastic with high thermal stability, i.e. plastics, which are mechanically and chemically-stable at the curing temperature of the item to be moulded. Examples of such plastics are thermosetting plastics, thermoresistant plastics, fibre-reinforced plastics. The resin systems preferably comprise one or more systems based on epoxy, polyurethane, polyester and/or vinylester, and other feasible systems known to the person skilled in the art. In a more preferred embodiment, the resin system is based on epoxy and particularly high temperature stable epoxy such as novolac. The reinforcing fibres are preferably glass fibres and/or carbon fibres, but other types of fibres are also usable. In a highly preferred embodiment, the fibre-reinforced plastic is resin deficient in the sense that not enough resin is available for all fibres to be wetted and a non-dense fibre-reinforced plastic is formed.

The air-permeable surface member may be prepared in several pieces, which are connected during assembly of the mould or connected to separate mould sections. The passage structure 14 in FIG. 7 varies considerably dependent on the origin of the air-permeable surface member 8. FIG. 7A shows a cross section of a sheet 22 having passage structures 14, which are prepared by perforating the otherwise dense sheet material, e.g. by drilling or electron beam perforation. Hence, substantially straight passage structures 14 are formed and each passage structure typically consists of one perforation or bore. In a preferred embodiment of the present invention, a high proportion, such as 90%, 95% or even 98%, of the passage structures 14 allows for such straight transportation routes of air between the active mould surface 12 and the air-drainage system 8. All of the passage structures may be substantially orthogonal to the active mould surface or some of the passage structures may be oriented with an angle different from orthogonal to the active mould surface. The latter may e.g. be advantageous in directing the passage structure directly into the network for air transportation and not into the solid material of the air-drainage structure. A mould with straight passage structures will have relatively predictable and reproducible properties.

In FIG. 7B and C sintered or cured structures are shown. In FIG. 7B a structure resembling a cross section of a sintered structure, such as sintered metal powder particles 23, is shown. FIG. 7C is a schematic top view of the positioning of openings to the passage structures in an air-permeable surface member comprising reinforcing fibres 24, such as woven fibre yams as shown in FIG. 7C. Fibre yarns may comprise 100-10,000 fibres or even more. The fibres are bonded together by an amount of cured resin 26 within the individual yarns and between crossing yarns. The amount of resin is insufficient to completely fill the space of the air-permeable member not occupied by the fibres and pores and openings between the yarns are hence formed. The openings 18 are formed in the space between by the crossing fibre yarns. Hence, the density of yarns may control the density of openings and a combination of the viscosity of the resin and the amount of resin used may control the size of the openings or the likelihood of the openings to be formed. It is emphasised that the actual number of open passage structures may depart considerably from the number of openings dependent on the number of fibre layers and the number of openings blocked by the solid part of the air-drainage system (see discussion on FIG. 6). In FIGS. 7B and C, passage structures 14 usually comprise a number of pores, holes or bores. In a preferred embodiment of the present invention, a high proportion, such as 90%, 95% or even 98%, of the passage structures 14 allows for such tortuous transportation routes of air between the active mould surface 12 and the air-drainage system 8. Another example of an air-permeable surface member with tortuous transportation routes of air is foamed materials.

The cross sectional area of the passage structures 14 is a relevant parameter for the mould according to the invention as thinner passage structures provide a higher pressure drop but at the same time reduce the probability of thermoplastic resin penetrating into the air-permeable surface member 8 during use of the mould. In a preferred embodiment of the invention, a large number, such as 90%, 95% or even 98%, of the passage structures 14 has an average cross-sectional area through the air-permeable surface member 8 corresponding to a diameter of less than 1 mm. In cases where the air-transportation distance is relatively short, corresponding diameters of less than 0.5 mm and preferably less than 0.25 mm may advantageously be used. For very short air-transportation distances, such as for a very stiff and thin fibre-reinforced plastic plate with relatively straight passage structures, corresponding diameters of between 25 μm to 150 μm may in many cases advantageously be utilised.

The sum of the passage structures and other pores or porosities (open as well as closed) In the bulk of the air-permeable surface member should be sufficiently low to prevent mechanical bonding between the air-permeable surface member and the moulded item during curing of the item. Furthermore, the air-permeable surface member should be adequately rigid (see below). In a preferred embodiment of the invention, the open volume of less than about 20 vol-%, however, lower open volumes, such as about 0.01 to 10 vol-%, would be advantageous in many cases. Especially for air-permeable surface members with drilled holes, open volumes of about 1 to 4 vol-%, such as about 2 vol-%, have proven to provide suitable properties. For air-permeable surface members prepared by sintering of powders or from foamed materials, open volumes considerably higher may in some cases be advantageous, particularly in the case of foamed materials.

In a preferred embodiment, the air-permeable surface member 8 comprises a relatively thin layer of solid material, such as e.g. 0.75 mm to 3 mm, which is positioned on a component with the air-drainage system 6 as shown in FIG. 1. In another preferred embodiment, the air-permeable surface member 8 is a relatively thick layer, such as e.g. 2.5 mm to 10 mm, with the air-drainage system 6 partially or completely integrated therein as shown in FIG. 5B and FIG. 6C, respectively.

What is more important than the thickness of the air-permeable surface member 8 is the actual air-transportation distance 20 through the air-permeable surface member 8. This distance, i.e. the distance travelled by air between the active mould surface 12 on the first side of the air-permeable surface member 8 and the air-drainage system 6 on the second side of the air-permeable surface member 8 should be relatively short to reduce the pressure drop. Experimental work has shown that the air-transportation distance 20 should preferably be less than about 5 mm for the larger indicated diameters of passage structures 14 and less than about 3 mm for medium diameter passage structure. For most air-permeable surface members, an air-transportation distance of about 0.5 to 2.5 mm provides a suitable trade-off between rigidity, strength and pressure drop. Typical values are air-transportation distances of about 0.75 to 2 mm.

In a preferred embodiment of the present invention, the air-permeable surface member is sufficiently rigid to prevent substantial deformation of the air-permeable surface member into the air-drainage system. In this embodiment, the deformation orthogonal to the active mould surface is less than 2 mm for moulds or parts of moulds with an air-drainage system having a relatively large cross sectional area. In more general cases, the deformation orthogonal to the active mould surface is less than 1 mm and it is advantageous when the deformation is less than 0.5 mm.

The advantage of this embodiment lies in the reduced surface deformation of the moulded part and/or that the air-drainage system remains open during the full moulding process including lay-up, pressing, heating and curing. The rigidity may e.g. be achieved through one or more of a high E-modulus, thickness, design considerations, such as varying thickness and connection to or influence by gas drainage structure, etc.

In yet another embodiment of the present invention, a part of or the whole of the air-permeable surface member 8 is heat resistant. If only a part of the air-permeable surface member is heat resistant, it is preferred that the part at and/or near the active mould surface is the heat resistant. By heat resistant is herein meant that this part of the air-permeable surface member 8 is mechanically stable (in one example below softening point) and chemically stable at the curing temperature of the item to be prepared in the mould. The curing temperature depends on the actual resin system used for the item to be prepared in the mould, and typically corresponds to temperatures up to at least 80 for low temperature systems like e.g. many polyesters, vinylesters and amine-containing epoxy systems. To include further resin systems, such as e.g. bisphenol A and DICY containing epoxy systems, this part of the air-permeable surface member 8 temperature should be heat-stable up to at least 120° C. and to increase the safety margin, which often leads to increased mould life, the temperature should preferably be heat-stable up to at least 180° C.

In another preferred embodiment, the air-permeable surface member comprises a sheet of air-permeable material. The air-permeable surface member with a sheet of air-permeable material may e.g. also comprise particles, pieces, islands, strips, etc., which may or may not themselves be air-permeable. However, in a particular modification of this embodiment, the air-permeable surface member consists of the sheet of air-permeable material, which is connected to the air-drainage system. By ‘connected to’ is meant that air transported through the air-permeable material has access to the network for transport of air and that the islands or the material wherein the network is arranged are secured to sheet.

In a preferred embodiment, the air-permeable surface member is coated with a mould-release agent on all or a part of the side, which is part of the active mould surface. It is preferred that all of this side of the air-permeable surface member is coated with the mould-release agent. The mould-release agent may be bonded permanently to the surface or a new layer of mould-release agent may need to be applied before each use of the mould or occasionally. An example of a suitable mould-release agent is PTFE (e.g. Teflon®). The mould-release agent coating may be provided to the air-permeable surface member before or after assembling of the mould. In a preferred embodiment, all the active mould surface is impregnated or coated with the mould-release agent.

### Subassembly

Another aspect of the present invention is a subassembly for a mould according to the main aspect of the invention and the above embodiments of moulds within this concept. The subassembly comprises an air-drainage system 6 and an air-permeable surface member 8, which is connected to the air-drainage system 6. Air may be transported between the surface of the air-permeable surface member away from the air-drainage system, and the air-drainage system 6 through the air-permeable surface member 8, when the subassembly is installed in a mould. The air-drainage system 6 of the subassembly is adapted to be connected to a support structure 4.

This subassembly comprises the components, which solve the same problems as the mould according to the invention and by the same means. The subassembly may be used for the manufacture of a mould according to the main aspect of the present invention, but the subassembly is particularly suitable for the reconstruction of used or traditional moulds. This is e.g. due to the relatively short time of installation of a subassembly on the mould being the support structure as only one component need be installed compared to separated air-permeable surface member and air-drainage structure.

In a preferred embodiment, the subassembly is capable of being plastically deformed to conform to a surface of a support, such as a support structure 4. As the air-permeable surface member should possess a suitable rigidity, it is preferred that the subassembly comprises a curable material, such as a resin, which may be cured after assembly of the mould or at least after plastic deformation of the subassembly to conform to the surface of the support. The curable material may be partially cured or substantially uncured.

The subassembly is preferably prepared by the same methods and materials as those described above for the air-permeable surface member and the air-drainage system and connected e.g. by adhesive or fasteners as described elsewhere.

The subassembly may be used for the manufacture of a mould according to the invention by a method comprising the steps of providing a support structure 4, providing a subassembly and securing the subassembly to the support structure 4, preferably with fasteners, adhesive and/or by curing or co-curing the subassembly with the support structure. In a preferred embodiment, the securing involves adhesive. In another embodiment, the subassembly is prepared by machining the air-transportation network or the air-drainage system into the air-permeable surface layer. Optionally, the further step of plastically deforming the subassembly to conform to a surface of the support structure 4 may be added prior to securing the subassembly to the support structure. It is emphasised that the support structure may be a mould not having an air-drainage system and/or an air-permeable surface member as the mould according to the present invention.

### Manufacturing of Mould

The mould according to the present invention is preferably prepared by a method comprising the following steps:
Providing a support structure. The support structure may or may not be a conventional mould, which is modified.
Providing an air-permeable surface member. The air-permeable surface member is preferably prepared by the method described elsewhere, but other methods of preparation are feasible.
Providing an air-drainage system. The air-drainage system is preferably prepared by the method described elsewhere, but other methods of preparation are feasible. In a preferred embodiment, the air-drainage system is partially or fully integrated in the support structure and/or the air-permeable surface member.
Optionally plastically deforming the air-permeable surface member and/or the air-drainage system to conform to a surface of the support structure,
Securing the air-permeable surface member to the support structure. This may optionally be realised via the air-drainage system. In a preferred embodiment, the securing involves fasteners and/or adhesive and/or curing or co-curing one or more of the support structure, air-drainage system and air-permeable surface member, however, in a more preferred embodiment, the securing involves adhesive. The adhesive is preferably based on epoxy or polyurethane or the same system as the resin used for the air-permeable surface layer 8 and/or the air-drainage system 6 if a resin is used for any of these.

### Use of the Mould

The mould according to the present invention is particularly suitable for the manufacturing of wind turbine blades on an industrial scale, as very large moulds may readily be prepared. Furthermore, the mould reduces the problem of presence of sink marks on the moulded item, which problem is well known in the manufacture of wind turbine blades.

The use of the mould for the manufacturing of a wind turbine blade preferably comprises the steps of:
Providing a mould 2 according to the invention.
Optionally positioning a material, preferably a thermoplastic material, to form a coating on the wind turbine blade in the mould 2. This step is relevant if an in-mould coating is desired. The material to form the coating may be shaped and secured temporarily in the mould by applying a vacuum to the air-drainage system, optionally in combination with heat for the shaping.
Applying vacuum to the air-drainage system 6. It is often advantageous to apply vacuum to the air-drainage system prior to initiation of the curing cycle of the item to be moulded, as the relatively stiff structure will comply less under the vacuum at low temperature and the open structure will hence tend to be evacuated better.
Placing fibres and/or resin in the mould 2 to form the wind turbine blade.
Optionally providing a vacuum enclosure between the mould 2 or the material to form the coating and the side of the wind turbine blade away from the mould 2. This is typically done with a vacuum bag or rather a side of a vacuum bag, which is connected airtight to the mould or the material to form the coating. The mould or material to form the coating will then act as the other side of the vacuum bag.
Applying pressure and/or vacuum to the wind turbine blade. Pressure would typically be applied on the side of the item to be moulded away from the active mould surface. Vacuum would be applied within a vacuum enclosure between the item to be moulded and the mould or the material to form the coating. In a highly advantageous embodiment, this vacuum is equal to or at a higher absolute pressure than the vacuum that is applied to the air-drainage system as air otherwise may be dragged into the mould from the air-drainage system leading to extensive sink marks on the moulded item. The potential to create such differential. vacuum is a great advantage of the present invention. The structure of the air-permeable surface member provides that the vacuum force between the coating and the active mould surface is higher at any position than the corresponding vacuum force between the vacuum enclosure and the item to be moulded. Typically, the difference in absolute pressure is less than 0.5 atm., such as in the order of 0.2 to 0.05 atm. The advantage is emphasised by the presence of the air-drainage system, which ensures that an air leakage through the support structure or a local blocking of the drainage structure is not damaging to the moulded item. It is emphasised that the differential pressure need not be present during all of the processing.
Optionally introducing further resin into the blade. This applies e.g. when a vacuum infusion method is used.
Curing the wind turbine blade. This is typically initiated by heat and carried out at an elevated temperature suitable for the resin system.
Releasing the wind turbine blade from the mould. This may optionally be facilitated by applying pressure via the air-drainage system. A pressure will hence build up in the air-drainage system and the air-permeable surface member. This will enhance the releasing on a micro scale, i.e. pushing out any moulding material, which has entered the passage structure during moulding, and/or on macro scale, i.e. by forming a pressurised airbag between the active mould surface and the moulded item.

In a preferred embodiment, the material to form the coating and/or the fibres and/or the resin is provided as prepregs.

In another preferred embodiment, the material to form the coating is a thermoplastic film, which is suitable for a wind turbine blade surface. This particularly concerns the weathering stability of the material. Preferably, the material to form the coating comprises acrylic-based material, polycarbonate, PCDF (Polyvinylidene fluoride), polyurethane or a blend comprising one or more of these. More preferably, the material is an acrylic material.

Moulds similar to the above described moulds, e.g. comprising a support structure 4, an air drainage system 6, an active mould surface 12 and an air-permeable surface member 8, through which air-permeable surface member 8 air may be transported between the active mould surface 12 and the air drainage system 6, and wherein the air-permeable surface member (8) forms substantially the entire active mould surface (12), for preparing in-mould coated members, may be used for preparing other in-mould coated members than wind turbine blades. Such other in-mould coated members are typically composite structures, e.g. fibre-reinforced plastic, like boats, structural elements, furniture, etc. Such mould may also be used for manufacturing of members which are not in-mould coated.

An individual feature or combination of features from an embodiment of the invention described herein, as well as obvious variations thereof, are combinable with or exchangeable for features of the other embodiments described herein, unless the person skilled in the art would immediately realise that the resulting embodiment is not physically feasible.

### Best Mode

The best mould according to the invention and the best mode for preparing a mould according to the invention known to the inventor is as follows:

A support structure is laid up on a model of the item to be moulded, which model is adjusted for the height of the air-drainage structure and the air-permeable surface member. The composite material is a laminate of carbon and/or glass fibre material and epoxy resin novolac with a T_{g} of about 180° C. The support structure is set, i.e. pre-cured or partially cured, in a vacuum enclosure at 60 to 80° C.

On the set support structure, a mesh having crossing strings with 1 mm×1 mm cross sections, said strings forming a 1 cm×1 cm squared grid is positioned. A curable epoxy novolac resin is distributed over the mesh to the height of the grid, i.e. filling the spaces between the strings. The resin is set at 60 to 80° C. and the mesh is removed.

For the air-permeable surface member, four layers of cross-ply glass fibres are positioned on the model of the item to be moulded and impregnated with epoxy novolac resin to almost complete saturation of the plies. Openings and passage structures are formed in the centre between the crossing yarns in each layer. The size and number of openings and passage structures are controlled by the resin content, i.e. the degree of saturation of the plies, and the density of yarns in the plies to a diameter of about 250 μm and a density of about 75 to 200 pr. cm². The air-permeable surface layer is set at 60 to 80° C. yielding an air-permeable surface member with a total thickness of about 1 mm. The air-permeable surface member is adhered to the air-drainage structure by epoxy novolac. The combined components of the mould are post cured at 150° C.

This yields a mould according to the invention having an air-drainage structure of 1 mm×1 mm channels separated by 1 cm×1 cm and an air-permeable surface member, which covers the air-drainage structure, with about 10 passage structures pr. cm² that are open to the active mould surface and the channels of the drainage structure. When cured at 150° C., the mould will easily withstand curing of material in the mould at 120° C., as the softening will not take place until about 150° C.

The best mode of using the mould as known to the inventor is the method comprising the steps of:
Positioning an acrylic film in the mould
Vacuum shaping the film to the mould by applying a vacuum in the air-drainage structure the shaping is facilitated by heating to soften the film
Laying up M9®-prepregs (Hexcel Composites®; based on epoxy with Bisphenol A and DICY (Dicyandiamid)) to form the laminate of the item to be moulded
Connecting a vacuum bag to the acrylic film covering the item to be moulded
Providing vacuum (about 0.2 atm absolute pressure) in the vacuum enclosure and a slightly lower absolute pressure in the air-drainage system (about 0.1 atm absolute pressure)
Curing the item to be moulded at about 120° C. for 60 minutes.
Cooling the mould
Releasing the vacuum and release the moulded item.

### TABLE OF IDENTIFICATION

2 Mould

4 Support structure

6 Air-drainage system

8 Air-permeable surface member

10 Channels for transportation of air

12 Active mould surface

14 Passage structures

16 Islands of solid material

17 Connector

18 Passage structure openings towards the active mould surface

20 Air-transportation distance

22 Sheet of air-permeable material

23 Powder particle

24 Fibres or fibre yarn

26 Cured resin

1. A mould for preparing of a wind turbine blade, a shell for a wind turbine blade or a large member intended to form part of a wind turbine blade comprising
a support structure,
an air-drainage system,
an active mould surface and
an air-permeable surface member, through which air-permeable surface member, air may be transported between the active mould surface and the air-drainage system,
wherein the air-permeable surface member forms substantially the entire active mould surface.

2. A mould according to claim 1, wherein the air-drainage system comprises a network for transport of air, preferably the network follows the active mould surface.

3. A mould according to claim 1, wherein the air-drainage system comprises islands of solid material, the space between which is comprised by the network for transport of air, preferably the space between the islands forms the two-dimensional network for transport of air.

4. A mould according to claim 2, wherein at least one of the islands has a cross section substantially resembling a geometrical shape, such as a circle, a triangle, a quadrangle or another polygon, preferably most or all of the islands have a cross section substantially resembling a geometrical shape, such as a circle, a triangle, a quadrangle or another polygon.

5. A mould according to claim 3, wherein at least two of the islands are connected by a connector and the height of said connector is smaller than the height of the islands.

6. A mould according to claim 2, wherein the air-drainage system comprises channels for transport of air.

7. A mould according to claim 6, wherein the cross section of most of the channels for transport of air is greater than 1 mm², preferably greater than 4 mm², more preferably greater than 9 mm².

8. A mould according to claim 6, wherein the distance between at least some of the parallel neighbouring channels for transport of air is between 0.4 cm to 20 cm, preferably between 0.5 cm to 5 cm, such as about 1 to 2 cm.

9. A mould according to claim 1, wherein the distance between at least some of the crossings of channels for transport of air is between 0.5 cm to 20 cm, preferably between 0.7 cm to 5 cm, such as about 1 to 2 cm.

10. A mould according claim 1, wherein the air-drainage system is at least partially integrated in the support structure, preferably the air-drainage system is fully integrated in the support structure.

11. A mould according to claim 1, wherein the air-drainage system is at least partially integrated in the air-permeable surface member, preferably the air-drainage system is fully integrated in the air-permeable surface member.

12. A mould according to claim 1, wherein the air-drainage system is positioned between the support structure and the air-permeable surface member, preferably as an independent member.

13. A mould according to claim 1, wherein the air-drainage system is intended to be airtight except towards the air-permeable surface member and at least one opening to a pressure control system.

14. A mould according to claim 1, wherein passage structures provide air-permeability through the air-permeable surface member, and the passage structures have openings towards the active mould surface at least 90% of said openings covering an area corresponding to a circle with a diameter of less than 0.5 mm, preferably between about 10 μm to 250 μm, more preferably between 25 μm to 150 μm, such as between 50 μm to 125 μm.

15. A mould according to claim 14, wherein the density of passage structure openings towards the active mould surface is 1 to 1000 pr. cm², preferably the density is 2 to 200 pr. cm², more preferably the density is 5 to 100 pr. cm².

16. A mould according to claim 13, wherein at least 90% the passage structures have an average cross-sectional area through the air-permeable surface member corresponding to a diameter of less than 1 mm, preferably less than 0.5 mm, more preferably less than 0.25 mm, such as between 25 μm to 150 μm.

17. A mould according to claim 13, wherein the air-permeable surface member has an open volume comprising the passage structures of less than 20 vol-%, more preferably an open volume of between 0.01 to 10 vol-% and most preferably 1 to 4 vol-%, such as about 2 vol-%.

18. A mould according to claim 13, wherein at least 90% of the passage structures allow for straight transportation routes of air between the active mould surface and the air-drainage system, such as via drilled holes or bores.

19. A mould according to claim 13, wherein at least 90% of the passage structures allow for tortuous transportation routes of air between the active mould surface and the air-drainage system, such as via pores in a sintered or cured material or a foamed material.

20. A mould according to claim 13, wherein the air-transportation distance through the air-permeable layer between the active mould surface and the air-drainage system is less than 5 mm, preferably less than 3 mm, more preferably between 0.5 to 2.5 mm, such as between 0.75 to 2 mm.

21. A mould according to claim 1, wherein the air-permeable surface member is sufficiently rigid to prevent substantial deformation of the air-permeable surface member into the air-drainage system, preferably the deformation of the air-permeable surface member orthogonal to the active mould surface 12 is less than 2 mm, more preferably less than 1 mm and most preferably less than 0.5 mm.

22. A mould according to claim 1, wherein at least a part of the air-permeable surface member is heat resistant, preferably said part of the air-permeable surface member is mechanically and chemically stable at the curing temperature of the item to be prepared in the mould, preferably at temperatures up to at least 80° C., more preferably at temperatures up to at least 120° C. and most preferably at temperatures up to at least 180° C.

23. A mould according to claim 1, wherein the air-permeable surface member comprises a sheet of air-permeable material, preferably the air-permeable surface member consists of said sheet, which is connected to the air-drainage system.

24. A mould according to claim 1,
wherein the air-permeable surface member comprises metal and/or plastic;
the metal is selected from the group consisting of steel, aluminium and alloys comprising one or more of these;
the plastic is a selected from the group consisting of thermosetting plastic, thermoresistant plastic, fibre-reinforced plastic, such as resin-deficient fibre-reinforced plastic, preferably comprising carbon fibres and/or glass fibres; the resin systems preferably comprising one or more systems based on epoxy, polyurethane, polyester and/or vinylester, such as epoxy novolac.

25. A mould according to claim 24, wherein the air-permeable surface member comprises a foamed material, such as a foamed thermosetting plastic or metal, or a cured, resin-deficient fibre-reinforced thermosetting plastic

26. A mould according to claim 13, wherein passage structures of the air-permeable surface member were achieved by mechanical drilling, laser drilling, water drilling and/or electron beam perforation of a substantially dense material.

27. A mould according to claim 1, wherein the air-permeable surface member is impregnated or coated with a mould-release agent, preferably all the active mould surface is impregnated or coated with the mould-release agent.

28. A mould according to claim 1, wherein the support structure itself is a mould.

29. A mould according to claim 1, wherein the air-permeable surface member and/or the air-drainage system is secured releasably to the air-drainage system and the support structured respectively.

30. A subassembly for a mould according to claim 1, said subassembly comprising:
an air-drainage system and
an air-permeable surface member connected to said air-drainage system, through which air-permeable surface member air may be transported between a surface of the air-permeable surface member away from the air-drainage system and the air-drainage system when installed in a mould,
and the air-drainage system is adapted to be connected to a support structure.

31. A subassembly according to claim 30, wherein the subassembly is capable of being plastically deformed to conform to a surface of a support, such as a support structure, preferably the subassembly comprises a curable material.

32. A method of manufacturing a mould according to claim 1, wherein the preparation of the air-drainage system comprises the steps of:
introducing recesses, such as grooves, in the support structure, and/or
introducing recesses, such as grooves, in the air-permeable surface member, and/or the combination of the following steps
positioning a network for transport of air on a support, such as a support structure,
casting a curable tooling paste over the mesh
curing the tooling paste
removing the mesh.

33. A method of manufacturing a mould according to claim 1, wherein the preparation of the air-permeable surface member comprises the steps of:
sintering a powder, such as a metal powder, under conditions which provide a non-dense sintered material, and/or
at least partially curing a thermosetting resin with fibres, such as carbon fibres and/or glass fibres, under conditions where an inferior volume of thermosetting resin relative to fibres is used, hence forming a non-dense member, and/or
curing or sintering a foamed material, such as a thermoplastic and/or the combination of the following steps:
providing a substantially dense, solid material, such as a sheet of metal or thermosetting plastic, optionally reinforced by fibres,
perforating the material by drilling, such as mechanical drilling, water drilling, laser drilling, or by electron beam perforation.

34. A method of manufacturing a mould for preparing of a wind turbine blade or a shell for wind turbine blade, the method comprising the steps of:
providing a support structure,
providing an air-permeable surface member,
providing an air-drainage system, said air-drainage system optionally being at least partially integrated in the support structure and/or the air-permeable surface member,
optionally plastically deforming the air-permeable surface member to conform to a surface of the support structure,
securing the air-permeable surface member to the support structures, optionally via the air-drainage system, said securing preferably involves fasteners, adhesive and/or curing or co-curing one or more of the support structure, air-drainage system sand air-permeable surface member, more preferably, said securing involves adhesive.

35. A method of manufacturing a mould according to claim 1, comprising the steps of:
providing a support structures,
providing a subassembly,
optionally plastically deforming the subassembly to conform to a surface of the support structure,
securing the subassembly to the support structure, preferably with fasteners, adhesive and/or by curing or co-curing the subassembly, more preferably with adhesive.

36. Use of a mould according to claim 1 for preparing a wind turbine blade.

37. A method of manufacturing a wind turbine blade comprising the steps of:
providing a mould according to claim 1,
optionally positioning and/or shaping a material to form a coating on the wind turbine blade in the mould,
applying vacuum to the air-drainage system,
placing fibres and/or resin in the mould to form the wind turbine blade,
optionally providing a vacuum enclosure between the mould or the material to form the coating and the side of the wind turbine blade away from the mould,
applying pressure and/or vacuum to the wind turbine blade,
optionally introducing further resin into the blade,
curing the wind turbine blade, and
releasing the wind turbine blade from the mould, optionally facilitated by applying pressure via the air-drainage system.

38. A method according to claim 37, wherein a differential vacuum is created during at least a part of the processing, preferably the vacuum provided in the vacuum enclosure is at a higher absolute pressure than the vacuum provided on the surface on the item to be moulded via the air-drainage system, hence the vacuum force between the surface of the item to be moulded and the active mould surface is higher at any position than the corresponding vacuum force between the vacuum enclosure and the item to be moulded.

39. A method according to claim 37, wherein the material to form the coating is a thermoplastic film suitable for a wind turbine blade surface with regard to weathering stability, preferably the material to form the coating comprises an acrylic-based material, polycarbonate, PCDF, polyurethane or a blend comprising one or more of these, more preferably the material is an acrylic material.

40. Use of a mould comprising a support structure, an air-drainage system, an active mould surface and an air-permeable surface member, through which air-permeable surface member air may be transported between the active mould surface and the air-drainage system, wherein the air-permeable surface member forms substantially the entire active mould surface, for preparing in-mould coated members.
